(19) United States
(12) Patent Application Publication
(10) Pub. No.: US 2018/0199394 A1
(43) Pub. Date: Jul. 12, 2018

(54) METHOD AND COMMUNICATION NODE FOR TRAFFIC AGGREGATION

(71) Applicant: Telefonaktiebolaget LM Ericsson (publ), Stockholm (SE)

(72) Inventors: Oumer Teyeb, Solna (SE); Icaro Leonardo J. Da Silva, Bromma (SE); Jari Vikberg, Järna (SE); Filip Mestanov, Sollentuna (SE)

(21) Appl. No.: 15/030,535

(22) PCT Filed: Feb. 19, 2016
(86) PCT No.: PCT/EP2016/053555

§ 371 Date: Apr. 19, 2016

Related U.S. Application Data
(60) Provisional application No. 62/129,063, filed on Mar. 6, 2015.

(51) Int. Cl. H04W 76/16; H04L 12/66; H04L 12/46

(52) U.S. Cl. CPC H04W 76/16; H04W 84/12; H04L 12/4633; H04L 12/66

(57) ABSTRACT

A method and communication node for providing traffic aggregation between a 3GPP network and a WLAN network when a wireless device is connected to an access point of the WLAN network. The communication node establishes an aggregation interface between the wireless device and a base station of the 3GPP network for carrying aggregation traffic traversing the WLAN network transparently. The communication node can then communicate data and/or messages over the WLAN network across the aggregation interface, without requiring any modifications or adaptions in the WLAN network. The communication node may be the wireless device or the base station.

### TECHNICAL FIELD

The present disclosure relates generally to a method and a communication node for providing traffic aggregation between a 3GPP network and a WLAN network when a wireless device is connected to the WLAN network.

### BACKGROUND

In the field of radio communication in wireless networks, the terms “wireless device” and “User Equipment, UE” are commonly used and will be interchangeably used in this disclosure to represent any mobile phone, tablet or device capable of radio communication with a wireless network such as a 3GPP network defined by the 3^{rd} Generation Partnership Project, 3GPP and a Wireless Local Area Network referred to as a WLAN network for short, including receiving downlink signals transmitted from a serving base station or access node and sending uplink signals to the base station or access node. Further, the terms “base station” and “eNB” will be interchangeably used in this disclosure to represent any node of a wireless network that can communicate uplink and downlink radio signals with wireless devices or UEs. Throughout this disclosure, the term eNB is thus frequently used instead of base station. The term “Access Point, AP” is further used herein to denote a network node in a WLAN or Wi-Fi network capable of radio communication with wireless devices or UEs. Also, The term “WLAN network” is used for short to denote a WLAN or Wi-Fi network and the term “3GPP network” is used to denote a network for radio access which is part of a cellular network.

FIG. 1A illustrates an overview of an Evolved Packet Core, EPC, architecture providing connectivity to one or more Packet Data Networks, PDNs. This architecture is defined in 3GPP TS 23.401 which comprises definitions of the PGW (PDN Gateway), SGW (Serving Gateway), PCRF (Policy and Charging Rules Function), MME (Mobility Management Entity) and mobile device (UE or wireless device). The wireless network for Long Term Evolution, LTE, radio access, called E-UTRAN, comprises one or more eNBs. In particular, FIG. 1A shows the architecture for 3GPP accesses. In those accesses, the radio interface is specified by 3GPP, e.g. the radio interface LTE-Uu.

FIG. 1B shows an extension to the EPC architecture in order to allow both 3GPP accesses and non-3GPP accesses. The term “non-3GPP access” is used herein to indicate that a radio interface is used which is not specified by 3GPP, such as a WLAN radio interface. See for example 3GPP TS 23.402.

A non-3GPP access may be either trusted or untrusted. A definition of trusted or untrusted is given in the 3GPP specifications. Simplified, it can be said that a trusted access is managed by an operator (e.g. an operator hotspot) whereas an untrusted access is not managed by the operator (e.g. a Wi-Fi access point at home). A security gateway called evolved Packet Data Gateway, ePDG, is used in the operator's network for a non-3GPP access from an “untrusted” domain. The UE typically sets up a secure tunnel to the ePDG using the SWu-interface, and there is also the S2b interface between ePDG and PGW, i.e. the PDN Gateway. A trusted non-3GPP access hosts a gateway, called Trusted Wireless Access Gateway, TWAG, not shown in FIG. 1B (see 3GPP TS 23.402 section 16). There is a point-to-point interface between UE and TWAG, and the S2a interface between TWAG and PGW.

Proper communication in a 3GPP network is dependent on the availability of sufficient radio resources, e.g. defined by time and frequency. Since the demands for mobile communication in a 3GPP network are steadily increasing due to increased usage of wireless devices and wireless services, it is of great interest to relieve the load in the 3GPP network whenever possible, e.g. by moving the traffic from the 3GPP network to a WLAN network. Techniques for enabling traffic aggregation between a 3GPP network and a WLAN network, sometimes referred to as 3GPP/WLAN interworking, have therefore been discussed and developed. In this description, “traffic aggregation” indicates that communication of data and/or messages is performed using two different networks, in this case a 3GPP network and a WLAN network.

The terms Wi-Fi and WLAN are used interchangeably throughout this disclosure. Most current Wi-Fi/WLAN deployments are totally separated from mobile networks such as 3GPP networks, and can be seen as non-integrated from the UE perspective. Most operating systems (OSs) for UEs such as Android™ and iOS®, support a simple Wi-Fi offloading mechanism where a UE immediately switches all its IP traffic from a 3GPP network to a Wi-Fi or WLAN network upon a detection of a suitable WLAN network with a received signal strength above a certain level. The decision to offload the UE to a Wi-Fi network or not may be subject to an access selection strategy and the term “Wi-Fi-if-coverage” may be used to refer to the aforementioned strategy of selecting Wi-Fi as access for the UE whenever such a network is detected.

There are several drawbacks of the above “Wi-Fi-if-coverage” strategy. Though the user/UE can save previous pass codes or similar for already accessed Wi-Fi Access Points (APs), hotspot login for previously non-accessed Access Points, APs usually requires some kind of user intervention, either by entering the pass code in a Wi-Fi Connection Manager (CM) or using a web interface. The connection manager CM is a software running on a UE and it is in charge of managing the network connections of the UE, taking into account user preferences, operator preferences, network conditions, etc. In order to avoid or reduce the above issues and others, solutions for aggregating traffic over a 3GPP network and a WLAN network have been developed, which may be referred to as 3GPP/WLAN aggregation.

However, the solutions developed so far for 3GPP/WLAN aggregation will impact the WLAN network such that processing, new functionality and equipment are required in the WLAN network to enable such 3GPP/WLAN aggregation. It is therefore a drawback that costly modifications must be made in the WLAN network, including in numerous access nodes therein, in order to enable the above-mentioned moving of traffic from the 3GPP network to the WLAN network according to the known solutions. Such modifications may impact both standardization and product implementation.

### SUMMARY

It is an object of embodiments described herein to address at least some of the problems and issues outlined above. It is possible to achieve this object and others by using a method and a node as defined in the attached independent claims.

According to one aspect, a method is performed by a communication node for providing traffic aggregation of a 3GPP network and a WLAN network when a wireless device is connected to the WLAN network. In this method, the communication node establishes an aggregation interface between the wireless device and a base station of the 3GPP network for carrying aggregation traffic traversing the WLAN network transparently. The communication node then communicates data and/or messages across the aggregation interface. The communication node performing this method may be the wireless device or the base station of the 3GPP network.

According to another aspect, a communication node is arranged to provide traffic aggregation of a 3GPP network and a WLAN network when a wireless device is connected to an access point of the WLAN network. The communication node comprises a processor and a memory, said memory comprising instructions executable by said processor whereby the communication node is configured to perform the above method. The communication node is thus configured, e.g. by means of an establishing module, to establish an aggregation interface between the wireless device and a base station of the 3GPP network for carrying aggregation traffic traversing the WLAN network transparently. The communication node is also configured, e.g. by means of a communicating module, to communicate data and/or messages across the aggregation interface.

It is an advantage of the above method and communication node that the traffic aggregation of the 3GPP network and the WLAN network does not require any modifications or adaptions in the WLAN network since the aggregation interface can carry the aggregation traffic traversing the WLAN network transparently, basically implying that the WLAN network is transparent to the communication of the aggregation traffic.

The above method and communication node may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1A illustrates an overview of the EPC architecture allowing for 3GPP access, according to the prior art.

FIG. 1B illustrates an overview of the EPC architecture allowing for 3GPP access and non-3GPP access, according to the prior art.

FIG. 2 is a flow chart illustrating a procedure in a communication node, according to further possible embodiments.

FIG. 3 is a signaling diagram illustrating how the solution may be implemented when the communication node is a wireless device, according to further possible embodiments.

FIG. 4 is a block diagram illustrating a communication node in more detail, according to further possible embodiments.

FIG. 5 illustrates a protocol stack in a wireless device allowing for traffic aggregation at the PDCP level.

FIG. 6 illustrates conventional traffic aggregation at the PDCP protocol level involving an eNB and a WLAN Access Point, AP.

FIG. 7 illustrates a conventional communication scenario using an interface between a 3GPP network and a WLAN network.

FIG. 8 illustrates an example of a communication scenario using an interface between a wireless device, denoted UE, and a base station over a WLAN network, according to further possible embodiments.

FIG. 9 illustrates an example of a header structure that can be used in the scenario of FIG. 8, according to further possible embodiments.

FIG. 10 illustrates another example of a communication scenario using an interface between a wireless device, denoted UE, and a base station over a WLAN network, according to further possible embodiments.

FIG. 11 illustrates an example of a header structure that can be used in the scenario of FIG. 10, according to further possible embodiments.

FIG. 12 illustrates another example of a header structure that can be used in the scenario of FIG. 10, according to further possible embodiments.

FIG. 13 illustrates another example of a header structure that can be used in the scenario of FIG. 10, according to further possible embodiments.

### DETAILED DESCRIPTION

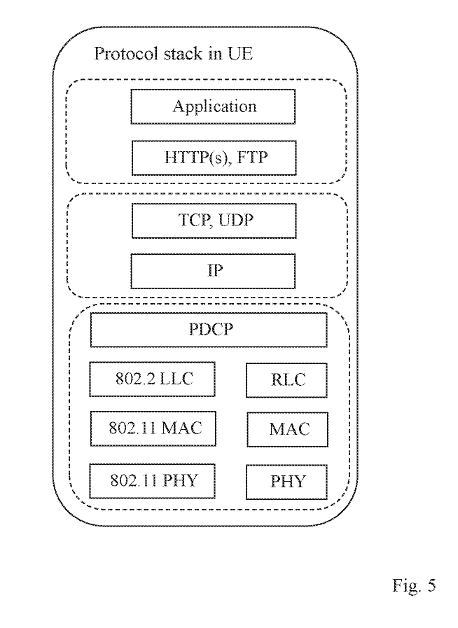

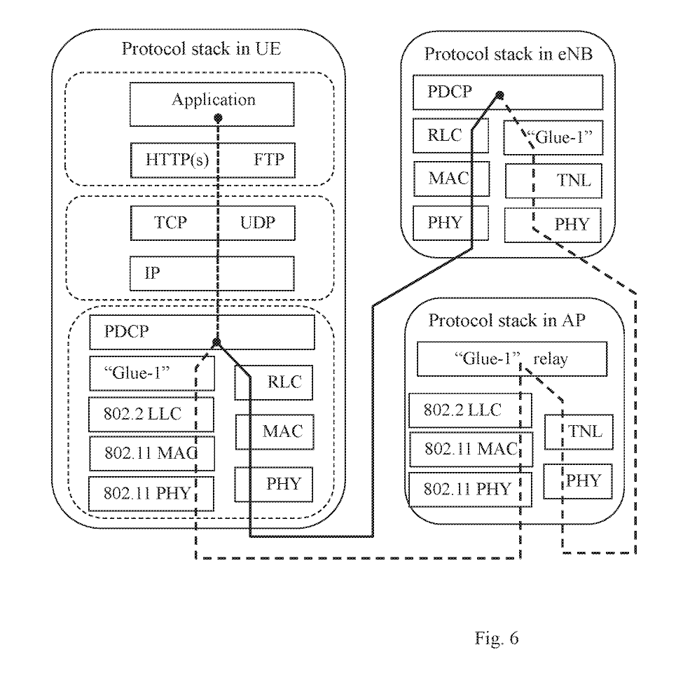

Briefly described, a solution is provided to enable usage of a WLAN network to reduce the radio traffic to and from a 3GPP network, without requiring any modifications and adaptions in the WLAN network which is a substantial advantage over the currently known solutions which require costly investments e.g. in the form of software for new or modified functionality in the access nodes of the WLAN network, as mentioned above. Some examples of such modifications will be briefly described later below with reference to FIGS. 5 and 6.

In the embodiments described herein, any modifications and adaptions in the WLAN network can be avoided by employing traffic aggregation of the 3GPP network and the WLAN network when a wireless device is connected to the WLAN network over an access point, such that the traffic to or from the wireless device will be communicated transparently to the WLAN network. In more detail, an aggregation interface is established between the wireless device and a base station of the 3GPP network for carrying aggregation traffic in such a manner that the aggregation traffic pass through the WLAN network transparently. The term “aggregation interface” thus represents a communication interface between the wireless device and the 3GPP base station via the WLAN network.

For example, the aggregation interface may be implemented as a tunnel through the access point and the WLAN network, so that the communication through the tunnel does not require any processing of the communicated information in the WLAN network whatsoever. The aggregation interface, e.g. tunnel, may be implemented via an evolved Packet Data Gateway, ePDG, in the 3GPP network, which will be described in more detail later below.

Throughout this disclosure, the term “tunnel” is used to generally represent a communication path between two communicating endpoints such that traffic comprising data and/or messages can be sent from one endpoint and received by the other endpoint without being intercepted, processed or changed by any intermediate node(s) or element(s) that may forward the traffic between the endpoints. In this solution, one endpoint of a tunnel may be the wireless device and the other endpoint of the tunnel may be the base station of the 3GPP network.

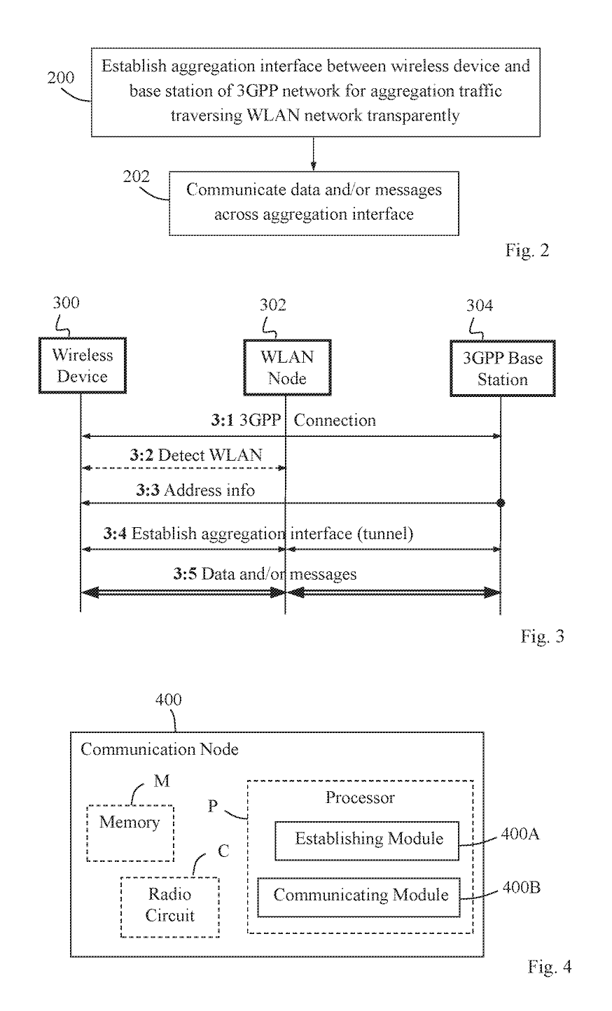

An example of how the solution may be employed will now be described with reference to the flow chart in FIG. 2 which illustrates a procedure with actions performed by a communication node, to accomplish the functionality described above. The communication node may be a base station of a 3GPP network or a wireless device. The communication node is operative for providing traffic aggregation between a 3GPP network and a WLAN network when a wireless device is connected to the WLAN network.

A first action 200 illustrates that the communication node establishes an aggregation interface between the wireless device and a base station of the 3GPP network for carrying aggregation traffic traversing the WLAN network transparently. In a next action 202, the communication node communicates data and/or messages across the aggregation interface. In this disclosure, the term “transparently” is used to indicate that the WLAN network is transparent to the communication of the aggregation traffic with data and/or messages in the sense that the WLAN network does not read, process or change the data and/or messages whatsoever. In other words, the WLAN network only forwards the traffic as is, without “doing” anything to it.

Thereby, radio communication of the data and/or messages to and from the wireless device can be executed by using a wireless connection to the WLAN network instead of using a wireless connection to the 3GPP network, thus not occupying radio resources in the 3GPP network, while the traffic aggregation between the 3GPP network and the WLAN network will not require any modifications or adaptions in the WLAN network which is thus an advantage over the currently known solutions. The communication node may be further operative to implement various examples and embodiments as follows.

In one possible embodiment, the aggregation interface may be implemented as a tunnel in which aggregation frames are encapsulated. The tunnel will thus run through the WLAN network so that any data or messages can be communicated in the aggregation frames to and/or from the wireless device in a transparent manner, meaning the WLAN network does not have to handle or process the aggregation frames whatsoever. The tunnel of this embodiment may be configured in different ways as follows.

A wireless device is generally configured with a protocol stack comprising various protocol levels such as the well-known protocols Medium Access Control, MAC, Radio Link Control, RLC, and Packet Data Convergence Protocol, PDCP. It is assumed that the base station is also configured with a protocol stack corresponding to the protocol stack in the wireless device. In further possible embodiments, the aggregation frames of the above-mentioned tunnel may comprise any of: MAC frames, RLC frames and PDCP frames. In another possible embodiment, the tunnel may be a so-called “Layer 2 over Layer 3” tunnel where Layer 2 frames are encapsulated in Layer 3 frames. In this embodiment, the Layer 2 frames are thus the above-mentioned aggregation frames of the tunnel.

When a tunnel is used for implementing the aggregation interface, the tunnel will be implemented by using a suitable tunnelling protocol. Some further possible embodiments may be that the tunnel is implemented as any of:
GTP, GPRS Tunnelling Protocol,
IPSec, Internet Protocol Security,
GRE, Generic Routing Encapsulation,
L2TP, Layer 2 Tunnelling Protocol,
L2TPv3, Layer 2 Tunnelling Protocol Version 3, and
L2F, Layer 2 Forwarding Protocol.

It is possible to use one or more of the above tunnelling protocols. For example, when a Layer 2 over Layer 3 tunnel is used as of the foregoing embodiment, both IPSec and GTP may be used simultaneously, or alternatively both IPSec and GRE may be used simultaneously. In another possible embodiment, the above traffic aggregation may comprise simultaneous use of 3GPP and WLAN links for transmission of packets belonging to an IP traffic flow. In this embodiment, the 3GPP link is a radio link between the wireless device and the base station, and the WLAN link is a radio link between the wireless device and an access point of the WLAN network.

In another possible embodiment, the communicated data and/or messages may be forwarded over an evolved Packet Data Gateway, ePDG, for security control of data packets in the 3GPP network by using an existing secure tunnel on an SWu interface between the wireless device and the ePDG. In a possible alternative embodiment, the communicated data and/or messages may be forwarded over an evolved Packet Data Gateway, ePDG, for security control of data packets in the 3GPP network by setting up a new secure tunnel for the aggregation traffic between the wireless device and the ePDG. Examples of how the latter two embodiments may be realized will be described in more detail later below.

In another possible embodiment, the communication node may be the wireless device, and in this case the wireless device may receive address information signalled from the base station and use the received address information for establishing the aggregation interface. In a possible alternative embodiment, the communication node may instead be the base station, and in this case the base station may receive address information signalled from the wireless device and use the received address information for establishing the aggregation interface. The address information in either case may comprise an IP address of the base station or the wireless device, respectively. In case the data and/or messages are Lo forwarded over an ePDG, the address information may comprise IP addresses of both the base station and the ePDG. In another possible embodiment, said address information may have a format which complies with a tunnelling protocol used on the aggregation interface, e.g. according to any of the examples of tunnelling protocols mentioned above.

In FIG. 3, an example is shown of how the solution may be realized when the above-described communication node is a wireless device 300. In this example, the wireless device 300 thus basically performs the above actions 200 and 202 for providing traffic aggregation between a 3GPP network and a WLAN network. The WLAN network comprises a WLAN node 302 such as an access point, and the 3GPP network comprises a base station 304.

A first action 3:1 illustrates that a conventional radio link, denoted 3GPP connection, is employed between the wireless device 300 and the base station 304. At some point, the wireless device 300 detects presence of the WLAN network, as illustrated by an action 3:2, which means that the wireless device 300 is able to use the WLAN network for communicating data and/or messages, e.g. when the signal strength from the WLAN network exceeds some threshold. In this action, one or both of the wireless device 300 and the WLAN node 302 may transmit detectable probing signals according to conventional procedures for WLAN detection, as indicated by a dashed two-way arrow.

The wireless device 300 can now decide to use the WLAN network for communication. A next action 3:3 illustrates that the wireless device 300 obtains address information from the base station 304, e.g. an IP address of the base station 304. This address information is then used by the wireless device 300 for establishing an aggregation interface between the wireless device 300 and the base station 304, in another action 3:4 which corresponds to action 200 in FIG. 2. A final action 3:5 illustrates that the wireless device 300 communicates data and/or messages across the aggregation interface, the communication being transparent to the WLAN network and the WLAN node 302, which corresponds to action 202 in FIG. 2. In this action, the aggregation interface or “tunnel” runs between the wireless device 300 and the base station 304, while the data and/or messages are transported over a radio interface between the wireless device 300 and the WLAN node 302 and over another interface between the WLAN node 302 and the base station 304.

The block diagram in FIG. 4 illustrates a detailed but non-limiting example of how a communication node 400 may be structured to bring about the above-described solution and embodiments thereof. In this figure, the communication node 400 may thus be configured to operate according to any of the examples and embodiments of employing the solution as described above, where appropriate, and as follows. The communication node 400 is shown to comprise a processor “P”, a memory “M” and a radio circuit “C” with suitable equipment for transmitting and receiving signals with data and messages in the manner described herein.

As in the examples discussed above, the communication node 400 described herein may be implemented in a wireless device or in a base station. The communication node 400 comprises means configured or arranged to perform at least the actions 200-202 of the flow chart illustrated in FIG. 2, in the manner described above. These actions may be performed by means of functional modules in the processor P in the communication node 400 as follows.

The communication node 400 is arranged to provide traffic aggregation between a 3GPP network and a WLAN network when a wireless device is connected to an access point of the WLAN network. The communication node 400 thus comprises a processor P and a memory M, said memory comprising instructions executable by said processor, whereby the communication node 400 is operable as follows.

The communication node 400 is configured to establish an aggregation interface between the wireless device and a base station of the 3GPP network for carrying aggregation traffic traversing the WLAN network transparently. This establishing operation may be performed by an establishing module 400A in the communication node 400, as described for action 200 above. The communication node 400 is also configured to communicate data and/or messages across the aggregation interface. This communicating operation may be performed by a communicating module 400B in the communication node 400, as described for action 202 above.

It should be noted that FIG. 4 illustrates some possible functional modules in the communication node 400 and the skilled person is able to implement these functional modules in practice using suitable software and hardware. Thus, the solution is generally not limited to the shown structure of the communication node 400, and the functional modules 400A-B may be configured to operate according to any of the features described in this disclosure, where appropriate.

The examples, embodiments and features described herein may thus be implemented in a computer program comprising instructions which, when executed on at least one processor, cause the at least one processor to carry out the above actions e.g. as described for FIG. 2. Further, the above-described examples and embodiments may be implemented in a carrier containing the above computer program, wherein the carrier is one of an electronic signal, optical signal, radio signal, or computer readable storage medium. The computer readable storage medium may be a compact disc or other carrier suitable for holding the computer program. Some examples of how the computer program and the carrier can be realized in practice are outlined below, and with further reference to FIG. 4.

The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

The memory M may comprise the above-mentioned computer readable storage medium or carrier on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM). The program modules could alternatively be distributed on different computer program products in the form of memories within the communication node 400.

It will now be described in more detail how traffic aggregation of a 3GPP network and a WLAN network can be accomplished when conventional solutions are used. First, some shortcomings associated with the conventional solutions that have been realized in the above-described embodiments, will be discussed.

In access selection between WLAN/Wi-Fi and 3GPP according to current solutions, no consideration of expected user experience is made except those considered in the UE implemented proprietary solution, and this can lead to a UE being handed over from a high data rate mobile network connection such as a 3GPP network to a low data rate Wi-Fi connection. Even though the UE's operating system OS or some high level software could be capable of taking offload decisions only when the signal strength on the Wi-Fi connection is considerably better than the 3GPP network link, there may still be limitations on the backhaul of the Wi-Fi Access Point (AP) that may end up being the bottleneck.

No consideration of the load conditions in the mobile network and Wi-Fi are made in the current access selection. As such, the UE might still be offloaded to a Wi-Fi AP that is serving several UEs while the 3GPP network (e.g. LTE) that it was previously connected to is rather unloaded.

Interruptions of on-going services can occur due to the change of IP address when the UE switches to the WLAN network. For example, a user who started a Voice over IP (VoIP) call while being connected to a 3GPP network is likely to experience a call drop when arriving home and the UE switches to the Wi-Fi network automatically. Though some applications may be capable of avoiding a call drop and survive the IP address change (e.g. Spotify®), the majority of current applications are not. This places a lot of burden on application developers if they have to ensure service continuity when switching from a 3GPP network to a WLAN network.

No consideration of the UE's mobility is made in the current conventional solutions for access selection. Due to this, a fast moving UE may end up being offloaded to a Wi-Fi AP for a short duration, just to be handed over back to the 3GPP network. This is specially a problem in scenarios like cafes with open Wi-Fi, where a user walking by or even driving by the cafe might be affected by this. Such ping pong between the Wi-Fi and 3GPP network can cause service interruptions as well as generate considerable unnecessary signaling (e.g. towards authentication servers).

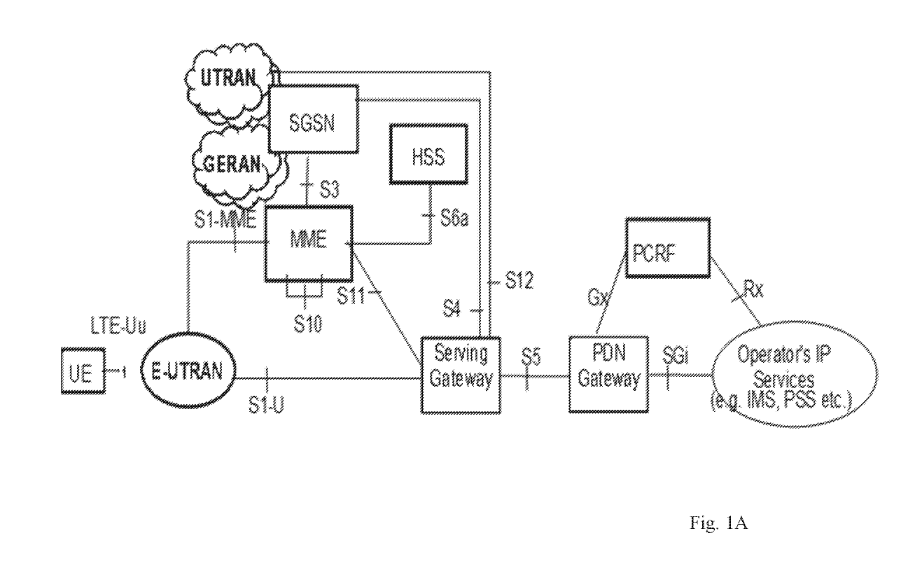

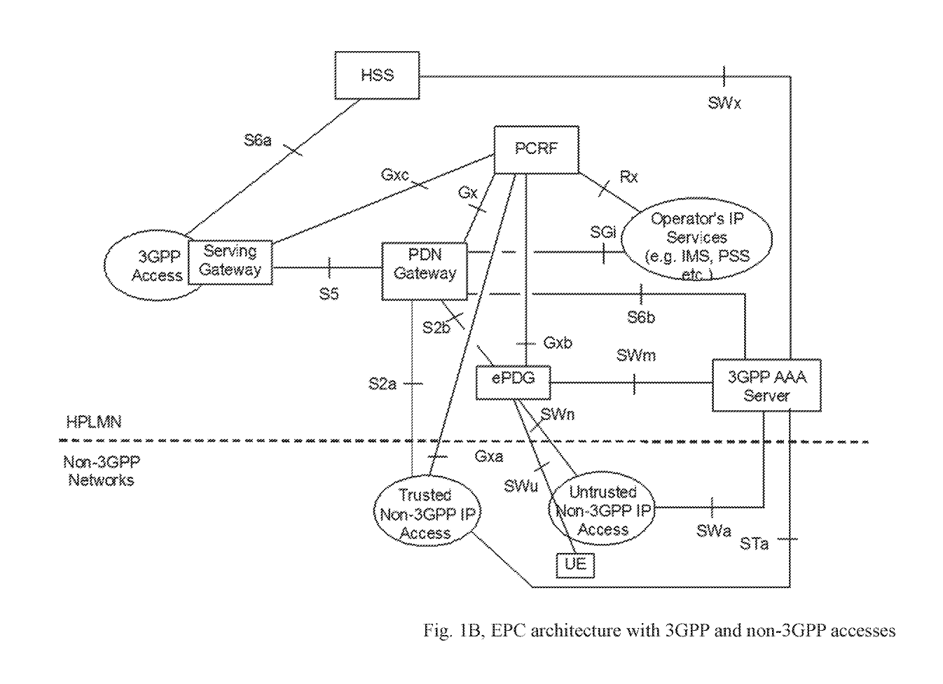

Recently, Wi-Fi has been subject to increased interest from cellular network operators, not only as an extension to fixed broadband access. The interest is mainly concerned with using the Wi-Fi technology as an extension, or alternatively to rely on cellular radio access network technologies, e.g. according to 3GPP, to handle the constantly increasing wireless bandwidth demands. Cellular operators that are currently serving mobile users with, e.g., any of the 3GPP technologies, such as LTE, UMTS/WCDMA, or GSM, may consider Wi-Fi as a wireless technology that can provide good support in their regular cellular networks. The term “operator-controlled Wi-Fi” typically refers to a Wi-Fi deployment that on some level is integrated with a cellular network operators existing network and where the 3GPP radio access networks and the Wi-Fi wireless access may even be connected to the same core network, such as in FIG. 1B, and provide the same services.

There is currently quite intense activity in the area of operator-controlled Wi-Fi in several standardization organizations. In 3GPP, activities to connect Wi-Fi access points to the 3GPP-specified core network is pursued, and in Wi-Fi Alliance, WFA, activities related to certification of Wi-Fi products are undertaken, which to some extent also is driven from the need to make Wi-Fi a viable wireless technology for cellular operators to support high bandwidth offerings in their networks. The term “Wi-Fi offload” is commonly used and points towards the fact that cellular network operators seek means to offload traffic from their cellular networks to Wi-Fi, e.g., in peak-traffic-hours and in situations when the cellular network for one reason or another needs to be off-loaded, e.g., to provide requested quality of service, maximize bandwidth or simply for coverage.

3GPP is currently working on specifying a feature/mechanism for WLAN/3GPP Radio interworking which improves operator control of how a UE performs access selection and of traffic steering between 3GPP and WLANs belonging to the operator or its partners. This mechanism may even be used for other, non-operator, WLANs as well.

For the mechanism of WLAN/3GPP Radio interworking, the Radio Access Network, RAN, may provide certain assistance parameters that could help the UE in the access selection. The RAN assistance information is typically composed of three main components, namely threshold values, offloading preference indicator (OPI) and WLAN identifiers, which can be used by the UE as a basis for selecting radio access. The UE is also provided with RAN rules/policies that make use of these assistance parameters.

The above-mentioned thresholds values could be for example for 3GPP signal related metrics such as RSRP (Reference Signal Received Power)/RSRQ (Reference Signal Received Quality)/RSCP (Received Signal Code Power)/EcNo, as well as for WLAN signal related metrics such as RCPI (Received Channel Power Indicator)/RSSI (Received Signal Strength Indicator), WLAN load/utilization, WLAN backhaul load/capacity, etc. One example of a RAN rule that uses the threshold value could be that the UE should connect to a WLAN if the RSRP is below the signaled RSRP threshold at the same time as the WLAN RCPI is above the signaled RCPI threshold (it is also discussed that the RAN should provide thresholds for when the UE should steer traffic back from WLAN to 3GPP). The RAN rules/policies are expected to be specified in a 3GPP specification such as TS 36.304 v12.0.0 and/or TS 36.331 v12.1.0.

With the above mechanism of WLAN/3GPP Radio interworking it is likely not desirable, or maybe not even feasible, that the UE considers any WLAN for access selection, when deciding where to steer its traffic. For example, it may not be feasible that the UE uses this mechanism to decide to direct its traffic to a WLAN network not belonging to the operator. Hence it has been proposed that the RAN should also indicate to the UE which WLANs the mechanism should be applied for by sending WLAN identifiers.

The RAN may also provide to the UEs additional parameters which are used in accordance with policies defined for an Access Network Discovery and Selection Function, shortly referred to as ANDSF policies, see also 3GPP TS 23.402. One proposed parameter is the Offloading Preference Indicator, OPI. One possibility for using the OPI is that it is compared to a threshold in the ANDSF policy to trigger different actions, another possibility is that OPI is used as a pointer to point and, and select, different parts of the ANDSF policy which would then be used by the UE.

The RAN assistance parameters (i.e. thresholds, WLAN identifiers, OPI) provided by RAN may be provided with dedicated signaling and/or broadcast signaling. Dedicated parameters can only be sent to the UE when having a valid RRC connection to the 3GPP RAN. A UE which has received dedicated parameters applies dedicated parameters; otherwise the UE applies the broadcast parameters. If no RRC connection is established between the UE and the RAN, the UE cannot receive dedicated parameters.

In 3GPP, it has been agreed that ANDSF should be enhanced for release-12 to use the thresholds and OPI parameters that are communicated by the RAN to the UE, and that if enhanced ANDSF policies are provided to the UE, the UE will use the ANDSF policies instead of the RAN rules/policies (i.e. ANDSF has precedence).

Within the scope of 3GPP Release-13, there has been a growing interest for realizing even tighter integration/aggregation between 3GPP and WLAN, for example, the same way as carrier aggregation between multiple carriers in 3GPP, where the WLAN is used just as another carrier. Such an aggregation is expected to make it possible for a more optimal aggregation opportunity as compared to the Multi-Path Transmission Control Protocol, MPTCP, as the aggregation is performed at a lower layer and as such the scheduling and flow control of the data on the WLAN and 3GPP links can be controlled by considering dynamic radio network conditions. FIG. 5 illustrates a typical protocol stack in a UE which allows for aggregation at the PDCP level.

FIG. 6 shows the main principle for traffic aggregation at the PDCP level and additional functionality may be needed in the PDCP-level aggregation, such that an additional protocol layer may be used between the PDCP layer and the 802.2 LLC layer to convey information about the UE and the radio bearer the traffic is associated with. This additional protocol layer is indicated as “Glue-1” in FIG. 6. This figure thus illustrates an example of how modified functionality is required for currently known solutions, which can be avoided in the embodiments described herein.

In the case of a standalone AP and eNB, i.e. AP and eNB are not co-located as shown in FIG. 6, the protocol stack for supporting aggregation is such that the LLC frames now have to be relayed towards the standalone eNB. FIG. 6 thus illustrates this for the case of PDCP level aggregation. In this case, once the LLC packet is decoded at the AP in the uplink direction from the UE to the AP, and the AP realizes that this packet is a PDCP packet that should be routed to an eNB, the forwarding operation can be performed via normal TCP/IP protocol stack.

A study item entitled “Multi-RAT Joint Coordination” has recently been started in 3GPP TSG RAN3, 3GPP TR 37.870. At RAN3 #84 the scope and requirements for the Multi-RAT Joint Coordination SI were further defined. In particular, for the 3GPP-WLAN coordination part, it was agreed to focus on non-integrated 3GPP/WLAN nodes since integrated nodes are a matter of implementation.

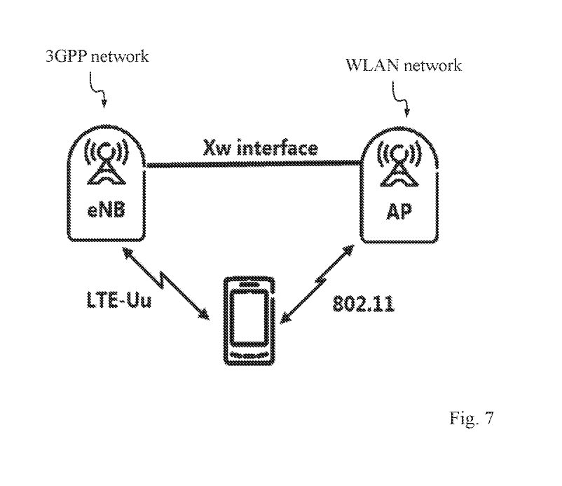

Among the requirements of the study item 3GPP TR 37.870 it is the investigation of potential enhancements of RAN interfaces and procedures to support the joint operation among different RATs, including WLAN. It has also been agreed that i) the coordination involving WLAN and 3GPP is in the priority of the study item and ii) the statements on 3GPP/WLAN must be complementary to RAN2 work R3-141512. Based on the recent contributions and offline discussions, this complement could be achieved by the specification of an interface between the E-UTRAN and WLAN, which may occur in future releases. Such architecture is shown in FIG. 7. The interface between the WLAN Access Point, AP, and the eNB in this figure is referred to as Xw interface. The Xw-interface may also be towards another node on the WLAN side, for example a Wi-Fi Access Controller (AC) or a Wi-Fi Gateway (GW).

When it comes to aggregation, the Xw interface can be used not only for forwarding the aggregated data, but also for control plane signaling regarding the aggregation, for example by using an Xw Application Protocol, XwAP. It should be noted that for the case of co-located APs and eNBs, a proprietary interface could be employed for the provisioning of similar functionalities. For example, the eNB can configure settings of some of the UE's WLAN parameters and behavior via RRC signaling. On the other hand, the eNB can use the XwAP of the Xw interface to configure the WLAN AP. In this case, functionality is required in the WLAN AP for implementing the Xw interface, which is not required by the embodiments described herein.

As indicated above, the embodiments described herein make it possible to reuse the currently installed functionality for handling wireless devices on the WLAN infrastructure side, and they are also backwards compatible with already existing and deployed WLAN infrastructure products.

The embodiments and examples described herein provide a new way of traffic aggregation which relies on establishing a new access interface between the eNB and the UE that can be deployed using any existing WLAN deployment without any need to add functionality to the WLAN infrastructure side. In this disclosure, “traffic aggregation” may comprise the simultaneous use of multiple access links, in this case 3GPP and WLAN links, for the transmission of packets belonging to a given IP traffic flow. Thereby, communication between a wireless device and a 3GPP base station can be accomplished when the wireless device uses an access by means of a radio link to a WLAN network. In other words, traffic over the 3GPP network is aggregated with traffic over the WLAN network. Further, the term “aggregation interface” represents a communication interface between the wireless device and the 3GPP base station via the WLAN network, possibly over an ePDG in the 3GPP network as described above. Different embodiments and examples are provided for how the UE and the eNB can establish the aggregation interface which may be denoted an SWua interface. The embodiments and examples described herein are applicable for both trusted and untrusted WLANs,

Unlike most of the previously proposed aggregation solutions, the solution described herein for traffic aggregation between a 3GPP network and a WLAN network is transparent to the WLAN network, which means that it can be installed with no impact on the currently installed WLAN infrastructure. This will not only facilitate the adoption of the embodiments herein, but also add value to the currently deployed infrastructure. It is thus an advantage that the solution can be implemented with low costs and efforts since it does not require any modification or introduction of new functionality in the WLAN network.

Some further possible but non-limiting examples 1-7 of how the proposed solution might be implemented in practice, will now be described. Below, the terms UE and eNB will be used although they could be replaced by wireless device and base station, respectively.

### EXAMPLE 1

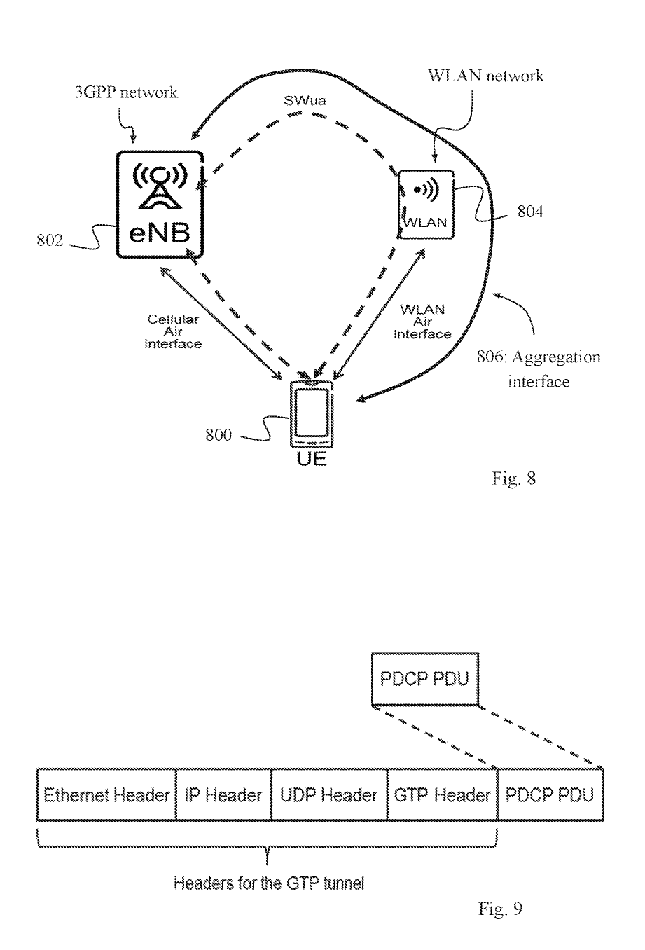

In this solution, after the traffic aggregation is triggered, e.g. when the UE detects the WLAN network with sufficient signal strength, a new interface, which may be referred to as SWua, is established as the above-described aggregation interface between the eNB and the UE. The interface is used to carry aggregation traffic that is meant to transparently traverse the WLAN network. The network architecture for this example is shown in FIG. 8 involving the UE 800, the eNB 802 and a WLAN node 804. The node 804 illustrated as “WLAN” in FIG. 8 is basically a WLAN termination function such as a WLAN AP, a WLAN AC or another suitable node or gateway in the WLAN network, or any combination of the above-mentioned WLAN nodes and functions. The aggregation interface between the eNB 802 and the UE 800 is denoted 806.

### EXAMPLE 2

As described above, the aggregation interface SWua may be implemented as a tunnel that encapsulates aggregated frames, e.g., MAC, RLC or PDCP frames. The tunneling may for example be based on either Layer 2 or Layer 3 Tunneling protocols, such as:
Layer 3 Tunneling, e.g. using any of:
   GTP—GPRS Tunneling Protocol,
   GRE—Generic Routing Encapsulation, and
   IPSec—Internet Protocol Security.
Layer 2 Tunneling, e.g. using any of:
L2TP—Layer 2 Tunneling Protocol,
L2TPv3—Layer 2 Tunneling Protocol Version 3, and
L2F—Layer 2 Forwarding Protocol.

Almost all currently existing UEs capable of communicating with a WLAN infrastructure support all of the above tunneling mechanisms and protocols. An example of header structure that can be used for tunneling according to the GTP is shown in FIG. 9 where PDU means Packet Data Unit. For example in the case of aggregated uplink traffic, the IP header could contain the UE's IP address as a source address and the eNB's IP address as the destination. The Ethernet header, which will be added by the WLAN functionality residing in the UE, could contain the MAC address of the UE as the source address and the MAC address of the IP gateway in the WLAN, e.g. a WLAN AC.

EXAMPLE 3

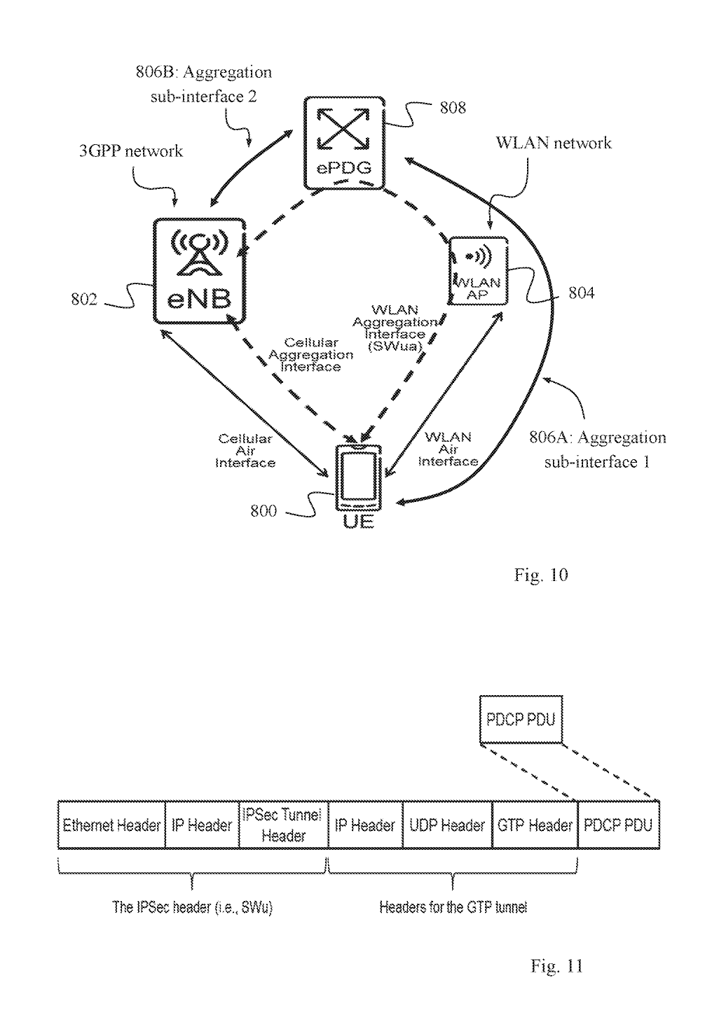

In this example, the interface is terminated at the UE on one side, and at the eNB on the other side and the traffic is forwarded via the WLAN network transparently and by the ePDG non-transparently. This example may be applied when the existing S2b network architecture is used for non-3GPP access to the EPC, as shown in FIG. 1B, by which the UE is connected and routes traffic to the ePDG. One part of this interface implementation requires a new interface between the eNB and the ePDG so that the ePDG can forward the aggregation traffic to and from the eNB. The network architecture for this example is shown in FIG. 10 likewise involving the UE 800, the eNB 802 and a WLAN node 804 with the addition of the ePDG 808. This example thus comprises a first existing aggregation “sub-interface” 806A between the UE 800 and the ePDG 808, e.g. implemented as an existing secure tunnel on the above-described SWu interface, and a second new aggregation “sub-interface” 806B between the ePDG 808 and the eNB 802. In this case the WLAN network is transparent to the communication over the sub-interface 806A.

Since there is already an existing interface between the UE 800 and the ePDG 808, that is the SWu interface, based on IPsec, one option would be to carry the aggregation traffic within the same tunnel on the SWu interface. An example header structure for this scenario is shown in FIG. 11. In this case, the IPSec header would be used in the same way as for the regular SWu interface. As in the previous example 2, the GTP tunnel would use IP addresses of the UE and the eNB in the IP Header.

Another possible option is to setup one additional tunnel between the ePDG and the UE, e.g. an additional IPSec tunnel, which can be used explicitly for carrying the aggregation traffic. In this case, the ePDG will need to implement functionality which would allow it to route the aggregation traffic from the newly established tunnel between the eNB and the UE.

### EXAMPLE 4

In this example, the establishment of the aggregation interface, e.g. as a tunnel, can be triggered either by the UE or by the eNB. Regardless of which side triggers the tunnel establishment, the WLAN network does not need to be notified or impacted.

### EXAMPLE 5

In this example, the eNB signals to the UE the address information needed for the UE to establish the aggregation interface, e.g. as a tunnel, towards the eNB. The address information may take different formats depending on the actual tunneling protocol.

### EXAMPLE 6

In other embodiments of the proposed solution, the UE signals to the eNB the address information needed for the eNB to establish the interface (e.g. tunnel) towards the UE. The address information may take different formats depending on the actual tunneling protocol.

### EXAMPLE 7

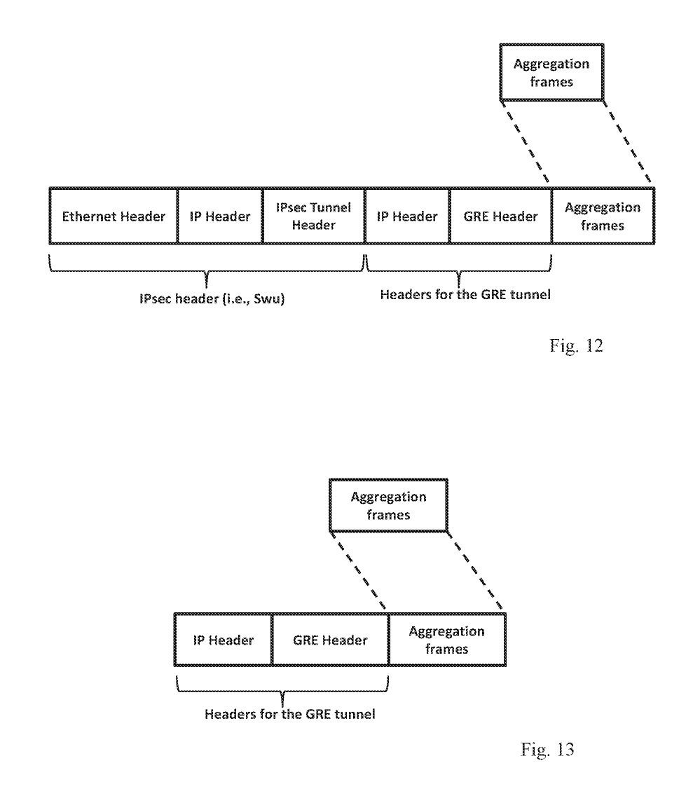

Since there is already an existing interface between the UE and the ePDG, that is the SWu interface, based on IPsec, one option would be to carry the aggregation traffic within the same tunnel on the SWu interface. An example header structure for this scenario is shown in FIG. 12. FIG. 12 shows an example header structure for use on the interface between the UE and the ePDG which may be used in the scenario of FIG. 10. In this case, the IPSec header would be used such as in a regular SWu interface. As in the previous examples 2 and 3, the GRE tunnel would use the IP addresses of the UE and the eNB in the IP header. FIG. 13 shows an example header structure between the ePDG and the eNB which may be used in the scenario of FIG. 10.

In the solution described herein, it is possible to establish the aggregation interface between the eNB and the UE as an IP interface, e.g. using an IP-based tunnel, that is used to carry the aggregation traffic, without the need to make modifications and adaptions to the WLAN network, neither standard-wise nor implementation-wise; hence any WLAN network would be able to transparently route the aggregated traffic over the newly proposed interface.

### ABBREVIATIONS

3GPP Third Generation Partnership Project

ANDSF Access Network Discovery and Selection Function

AP Access Point

eNB evolved Node B

EPC Evolved Packet Core

ePDG evolved Packet Data Gateway

GPRS General Packet Radio Service

IEEE Institute of Electrical and Electronics Engineers

IP Internet Protocol

HSS Home Subscriber Server

LLC Logical Link Control

MAC Medium Access Control

MME Mobility Management Entity

MPTCP Multipath Transmission Control Protocol

OPI Offloading Preference Indicator

PCRF Policy and Charging Rules Function

PDN Packet Data Network

PDCP Packet Data Convergence Protocol

PDG Packet Data Gateway

PGW PDN Gateway

PHY Physical layer

RAN Radio Access Network

RAT Radio Access Technology

RCPI Received Channel Power Indicator

RLC Radio Link Control

RRC Radio Resource Control

RSCP Received Signal Code Power

RSRP Reference Signal Received Power

RSRQ Reference Signal Received Quality

RSSI Received Signal Strength Indicator

SGW Serving Gateway

SGSN Serving GPRS support node

TWAG Trusted Wireless Access Gateway

UE User Equipment

UMTS Universal Mobile Telecommunications System

WFA Wi-Fi Alliance

WLAN Wireless Local Area Network

While the solution has been described with reference to specific exemplifying embodiments, the description is generally only intended to illustrate the inventive concept and should not be taken as limiting the scope of the solution. For example, the terms “communication node”, “wireless device”, “base station”, “access point”, “3GPP network”, “WLAN network”, “traffic aggregation”, “aggregation interface” and “address information” have been used throughout this disclosure, although any other corresponding entities, functions, and/or parameters could also be used having the features and characteristics described here. The solution is defined by the appended claims.

1. A method performed by a communication node for providing traffic aggregation of a 3GPP network and a WLAN network when a wireless device is connected to the WLAN network, the method comprising:
establishing an aggregation interface between the wireless device and a base station of the 3GPP network for carrying aggregation traffic traversing the WLAN network transparently, and
communicating data and/or messages across the aggregation interface.

2. A method according to claim 1, wherein the aggregation interface is implemented as a tunnel in which aggregation frames are encapsulated.

3. A method according to claim 2, wherein the aggregation frames comprise any of: Medium Access Control, MAC, frames, Radio Link Control, RLC, frames and Packet Data Convergence Protocol, PDCP, frames.

4. A method according to claim 2, wherein the tunnel is a Layer 2 over Layer 3 tunnel where Layer 2 frames are encapsulated in Layer 3 frames.

5. A method according to claim 2, wherein the tunnel is implemented as any of:
GTP, GPRS Tunnelling Protocol,
IPSec, Internet Protocol Security,
GRE, Generic Routing Encapsulation,
L2TP, Layer 2 Tunnelling Protocol,
L2TPv3, Layer 2 Tunnelling Protocol Version 3, and
L2F, Layer 2 Forwarding Protocol.

6. A method according to claim 1, wherein said traffic aggregation comprises simultaneous use of 3GPP and WLAN links for transmission of packets belonging to an IP traffic flow.

7. A method according to claim 1, wherein the communicated data and/or messages are forwarded over an evolved Packet Data Gateway, ePDG, for security control of data packets in the 3GPP network by using an existing secure tunnel on an SWu interface between the wireless device and the ePDG.

8. A method according to claim 1, wherein the communicated data and/or messages are forwarded over an evolved Packet Data Gateway, ePDG, for security control of data packets in the 3GPP network by setting up a new secure tunnel for the aggregation traffic between the wireless device and the ePDG.

9. A method according to claim 1, wherein the communication node is the wireless device, and wherein the wireless device receives address information signalled from the base station and uses the received address information for establishing the aggregation interface.

10. A method according to claim 1, wherein the communication node is the base station, and wherein the base station receives address information signalled from the wireless device and uses the received address information for establishing the aggregation interface.

11. A method according to claim 9, wherein said address information has a format which complies with a tunnelling protocol used on the aggregation interface.

12. A communication node arranged to provide traffic aggregation of a 3GPP network and a WLAN network when a wireless device is connected to an access point of the WLAN network, the communication node comprising a processor (P) and a memory (M), said memory comprising instructions executable by said processor whereby the communication node is configured to:
establish an aggregation interface between the wireless device and a base station of the 3GPP network for carrying aggregation traffic traversing the WLAN network transparently, and
communicate data and/or messages across the aggregation interface.

13. A communication node according to claim 12, wherein the communication node is configured to implement the aggregation interface as a tunnel in which aggregation frames are encapsulated.

14. A communication node according to claim 13, wherein the aggregation frames comprise any of: MAC frames, RLC frames and PDCP frames.

15. A communication node according to claim 13, wherein the tunnel is a Layer 2 over Layer 3 tunnel where Layer 2 frames are encapsulated in Layer 3 frames.

16. A communication node according to claim 13, wherein the communication node is configured to implement the tunnel as any of:
GTP, GPRS Tunnelling Protocol,
IPSec, Internet Protocol Security,
GRE, Generic Routing Encapsulation,
L2TP, Layer 2 Tunnelling Protocol,
L2TPv3, Layer 2 Tunnelling Protocol Version 3, and
L2F, Layer 2 Forwarding Protocol.

17. A communication node according to claim 12, wherein said traffic aggregation comprises simultaneous use of 3GPP and WLAN links for transmission of packets belonging to an IP traffic flow.

18. A communication node according to claim 12, wherein the communication node is configured to forward the communicated data and/or messages over an evolved Packet Data Gateway, ePDG, for security control of data packets in the 3GPP network by using an existing secure tunnel on an SWu interface between the wireless device and the ePDG.

19. A communication node according to claim 12, wherein the communication node is configured to forward the communicated data and/or messages over an evolved Packet Data Gateway, ePDG, for security control of data packets in the 3GPP network by setting up a new secure tunnel for the aggregation traffic between the wireless device and the ePDG.

20. A communication node according to claim 12, wherein the communication node is the wireless device, and wherein the wireless device is configured to receive address information signalled from the base station and to use the received address information for establishing the aggregation interface.

21. A communication node according to claim 12, wherein the communication node is the base station, and wherein the base station is configured to receive address information signalled from the wireless device and to use the received address information for establishing the aggregation interface.

22. A communication node according to claim 20, wherein said address information has a format which complies with a tunnelling protocol used on the aggregation interface.

23. (canceled)

24. A communication node arranged to provide traffic aggregation of a 3GPP network and a WLAN network when a wireless device is connected to an access point of the WLAN network, wherein the communication node comprises:
an establishing module configured to establish an aggregation interface between the wireless device and a base station of the 3GPP network for carrying aggregation traffic traversing the WLAN network transparently, and
a communicating module configured to communicate data and/or messages across the aggregation interface.

25. A communication node according to claim 24, wherein the communication node is configured to implement the aggregation interface as a tunnel in which aggregation frames are encapsulated.

26. A communication node according to claim 25, wherein the aggregation frames comprise any of: MAC frames, RLC frames and PDCP frames.

27. A communication node according to claim 24, wherein the tunnel is a Layer 2 over Layer 3 tunnel where Layer 2 frames are encapsulated in Layer 3 frames.

28. A communication node according to claim 25, wherein the communication node is configured to implement the tunnel as any of:
GTP, GPRS Tunnelling Protocol,
IPSec, Internet Protocol Security,
GRE, Generic Routing Encapsulation,
L2TP, Layer 2 Tunnelling Protocol,
L2TPv3, Layer 2 Tunnelling Protocol Version 3, and
L2F, Layer 2 Forwarding Protocol.

29. A communication node according to claim 24, wherein said traffic aggregation comprises simultaneous use of 3GPP and WLAN links for transmission of packets belonging to an IP traffic flow.

30. A communication node according to claim 24, wherein the communication node is configured to forward the communicated data and/or messages over an evolved Packet Data Gateway, ePDG, for security control of data packets in the 3GPP network by using an existing secure tunnel on an SWu interface between the wireless device and the ePDG.

31. A communication node according to claim 24, wherein the communication node is configured to forward the communicated data and/or messages over an evolved Packet Data Gateway, ePDG, for security control of data packets in the 3GPP network by setting up a new secure tunnel for the aggregation traffic between the wireless device and the ePDG.

32. A communication node according to claim 24, wherein the communication node is the wireless device, and wherein the wireless device is configured to receive address information signalled from the base station and to use the received address information for establishing the aggregation interface.

33. A communication node according to claim 24, wherein the communication node is the base station, and wherein the base station is configured to receive address information signalled from the wireless device and to use the received address information for establishing the aggregation interface.

34. A communication node according to claim 32, wherein said address information has a format which complies with a tunnelling protocol used on the aggregation interface.
